(19) United States
(12) Patent Application Publication
(10) Pub. No.: US 2019/0116767 A1
(43) Pub. Date: Apr. 25, 2019

(54) APPARATUS FOR SHELLFISH AQUACULTURE

(71) Applicants: Angelo DePaola, Coden, AL (US); Gary Sunderland, Surf City, NC (US)

(72) Inventors: Angelo DePaola, Coden, AL (US); Gary Sunderland, Surf City, NC (US)

(21) Appl. No.: 16/167,521

(22) Filed: Oct. 22, 2018

Related U.S. Application Data
(60) Provisional application No. 62/575,464, filed on Oct. 22, 2017.

(51) Int. Cl. A01K 61/55; A01K 61/60

(52) U.S. Cl. CPC A01K 61/55; A01K 61/60

(57) ABSTRACT

A pneumatically controlled shellfish aquaculture apparatus is provided. The apparatus has a base formed by two spaced tubes. An air supply line is connected to each tube for providing air to the tubes from a compressed air source. An exhaust port is positioned on the bottom of each tube at an end opposite the air supply lines. The apparatus also has a support structure rigidly connecting the tubes for supporting containers for holding shellfish. Each air supply line is connected to a manifold for controlling airflow to the tubes. Air is used to displace water in the tubes by pushing the water out of the exhaust ports in order to float the apparatus. To submerge the apparatus, the tubes are depressurized to allow water to displace the air in the tubes. When floating, the tubes lift the apparatus and the containers out of the water to allow air desiccation in order to prevent bio-fouling of the equipment and shellfish.

### CROSS REFERENCES

This application claims the benefit of U.S. Provisional Application No. 62/575,464, filed on Oct. 22, 2017, which application is incorporated herein by reference.

### FIELD OF THE INVENTION

The present invention refers generally to a shellfish aquaculture apparatus and, more specifically, to a pneumatically controlled apparatus for shellfish aquaculture.

### BACKGROUND

It is estimated that over 90% of oysters, clams, and mussels produced for consumption worldwide come from aquaculture farms. In particular, due to loss of wild oyster reefs, small-scale aquaculture of oysters has increased significantly in recent years. Typical shellfish aquaculture farms utilize baskets, cages, trays, racks, or similar containers for holding the oysters either on the water bottom or off-bottom. Generally, oysters grow best when submerged in nutrient-rich brackish water elevated above the bottom to prevent contact with destructive worms or suffocation from silting. When growing oysters, approximately once a week they must be raised above the surface for approximately a 24-hour period. This permits the oysters to air dry, killing barnacles, algae and other micro-organisms which attach to their shells. This weekly process is referred to as desiccation.

Once the oysters have dried they must be re-submerged to grow until the next desiccation is required. Between desiccations, the oysters and aquaculture equipment remain submerged in natural water bodies for extended periods of time during the growth of the oyster to a matured state suitable for harvest. During submerged periods, a biofilm of microorganisms may form on outer surfaces of the shellfish and the submerged aquaculture equipment, which can lead to the attachment of nuisance bio-fouling organisms such as barnacles and unwanted bivalve shellfish. Bio-fouling organisms create nuisance by clogging mesh or pores in shellfish containers, which reduces water flow through the containers and food availability for the shellfish, thereby slowing growth of culture shellfish. Additionally, bio-fouling organisms attach directly to shellfish causing visual defects that reduce market value. Unwanted organisms also add excessive weight to the system and can damage moving parts of the aquaculture equipment. Periodic emergence of the equipment and shellfish in the air above the sea surface desiccates the biofilm before it sufficiently establishes to permit attachment of bio-fouling organisms. Emergence of the equipment eliminates the need to pressure wash or clean equipment and shellfish by other means after bio-fouling organisms colonize the exposed surfaces.

In productive shellfish growing areas such as the Gulf of Mexico, desiccation of gear at weekly intervals is typically required to control bio-fouling. Currently employed methods for bio-fouling control rely on intensive and potentially unsafe manual labor practices. Typical aquaculture systems comprise rectangular containers constructed of heavy plastic coated wire mesh that are assembled with multiple container compartments for holding flexible plastic mesh bags of varying mesh sizes that contain shellfish at various growth stages. The containers typically have two air-filled floats attached to the top of the containers on the outside edges on opposing sides to maximize stability to wave action. The air-filled floats provide adequate buoyancy to float the oyster-filled containers below the surface of the water for growing the oysters. The normal bio-fouling practice employed with floating aquaculture systems is to manually flip the containers upside down so the floats are on the bottom of the containers. Float buoyancy elevates the oysters and the containers in the air above the water surface. In shallow areas, flipping the containers is often done by wading, but boats are required to work deeper or colder waters. Relatively calm waters are required to flip the containers from boats. After a desiccation period of about 24 hours, the containers are manually flipped back into the growth position until the next desiccation treatment. This method of bio-fouling control is labor intensive and time consuming, which drives up oyster production costs. In addition, there are safety risks involved with the manual flipping of the oyster-filled containers, which can be extremely heavy. To limit the weight, smaller containers or groups of containers must be utilized, thereby limiting the potential scale of an operation. Current methods of shellfish aquaculture require large tracts of publicly-owned water bottoms and the waters located above to grow oysters.

Significant manual labor is required to manipulate and maintain the gear associated with these methods and to accomplish the desiccation process.

Therefore, a need exists in the art for a system which permits the cultivation of oysters in a small area and allows for the desiccation process with minimum labor.

### SUMMARY

The shellfish aquaculture apparatus of the present disclosure automates air desiccation of bivalve shellfish produced in off-bottom containerized aquaculture systems for the purposes of controlling bio-fouling on the surfaces of the shellfish and aquaculture equipment. In one aspect, a pneumatically controlled apparatus for shellfish aquaculture comprises a base comprising two spaced tubes each having a first end and a second end, a supply line secured to the first end of each tube for providing air to the tubes, an exhaust port positioned at the second end of each tube for displacing water from the tubes, and a support structure rigidly connecting the tubes. The support structure is used to support containers for holding oysters or other shellfish. Each air supply line may be connected to a manifold for supplying air to each of the tubes. The manifold has a connection nozzle for a primary air supply line from an air source. The air source is preferably a pressurized tank, such as a SCUBA tank, or an air compressor. The manifold has valves for individually controlling the flow of air to each of the tubes.

The shellfish aquaculture apparatus is configured for use in two positions: a floating position and a submerged position. The tubes are filled with air when in the floating position and with water when in the submerged position. When in the floating position, the containers and shellfish contained therein are lifted above the surface of the water. The containers and shellfish can be held in this position for a period of time sufficient to allow air desiccation in order to prevent the formation of biofilm on the containers and shellfish, which is a precursor to bio-fouling by barnacles or other unwanted organisms. Other shellfish husbandry activities such as stocking containers, size-sorting shellfish, grading, inspections to monitor the growth and quality of the stock, and harvesting are also facilitated while the apparatus is in the floating position. Additionally, the apparatus can be disconnected from moorings and towed away to avoid hazards or towed to a more favorable location for growth or acquisition of quality growth characteristics such as salinity. When in the submerged position, the tubes rest on the water bottom and hold the containers and shellfish contained therein off the water bottom to allow shellfish growth before harvesting.

To move the apparatus from the submerged position to the floating position, air is supplied to the tubes in order to displace the water in the tubes. The air supply lines are preferably connected to a top side of each tube, and pressurized air supplied via the lines displaces the water in the tubes by pushing the water out of each respective exhaust port located on a bottom side of each tube at an opposite end of each tube. As the water is displaced by air, the apparatus will rise to the surface of the water. When substantially all of the water in each tube has been displaced by air, the apparatus will float on the surface of the water such that the containers and shellfish contained therein are above the water surface. The process of floating the apparatus is repeated each time bio-fouling treatment is required.

Once bio-fouling treatment is complete, the apparatus may be returned to the submerged position by depressurizing the tubes. Once the air pressure is removed from the tubes, the weight of the apparatus will cause water to displace the air in the tubes by entering each of the exhaust ports located on the bottom side of each tube. The end of the apparatus with the exhaust ports will then sink and rest on the water bottom to provide stability to the apparatus. As the tubes are depressurized to displace the air in the tubes with water, the opposing end of the apparatus to which the air supply lines are connected will then sink to the water bottom, and the apparatus will be in the submerged position.

The spaced tubes of the present design provide a floating “catamaran” design with the tubes functioning as pontoons, which is advantageous compared to known shellfish aquaculture systems. The catamaran design is inherently stable both fore-and-aft and athwart ship. It will ride comfortably in a moderate seaway. Anchoring and mooring forces are greatly reduced by the small bow area presented to breaking waves, while the tunnel formed between the tubes permits the water to flow through the vessel unrestricted. During storm conditions, the apparatus can be submerged to escape the impact of high-energy waves. In addition, because containers are not flipped manually, the capacity of a unit of containers can be increased substantially, typically from less than 1,000 shellfish to greater than 10,000 shellfish. The apparatus also reduces risks associated with manual flipping, such as falls, drowning, hypothermia, wound infections, stings or bites from jellyfish or other sea animals, or other similar risks. Additionally, the round forms of the structural members are labor-friendly having no hard corners or sharp edges to injure workers while loading and unloading oysters.

Accordingly, one object of the present invention is to provide a shellfish aquaculture apparatus having pneumatic flotation control for sinking and floating the apparatus in order to facilitate all phases of shellfish production and harvest. Another object of the present invention is to provide a method of bio-fouling treatment that does not require shellfish containers to be flipped.

### DESCRIPTION OF THE DRAWINGS

These and other features, aspects, and advantages of the present invention will become better understood with regard to the following description, appended claims, and accompanying drawings where:

FIG. 1 is a top perspective view of a shellfish aquaculture apparatus in accordance with the present disclosure.

FIG. 2 is a bottom perspective view of a shellfish aquaculture apparatus in accordance with the present disclosure.

FIG. 3 is a top perspective view of a shellfish aquaculture apparatus in accordance with the present disclosure.

FIG. 4 is a perspective view of a manifold for use with a shellfish aquaculture apparatus in accordance with the present disclosure.

FIG. 5 is a partial front perspective view of a tube of a shellfish aquaculture apparatus in accordance with the present disclosure.

FIG. 6 is a partial front perspective view of a shellfish aquaculture apparatus in accordance with the present disclosure.

FIG. 7 is a top perspective view of a shellfish aquaculture apparatus in accordance with the present disclosure.

FIG. 8 is a top perspective view of a shellfish aquaculture apparatus in accordance with the present disclosure.

FIG. 9 is a side cross-sectional view of a tube and bulkhead for a shellfish aquaculture apparatus in accordance with the present disclosure.

### DETAILED DESCRIPTION

In this disclosure, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components. The term tubes, tanks, and pontoons, as used herein, are interchangeable.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

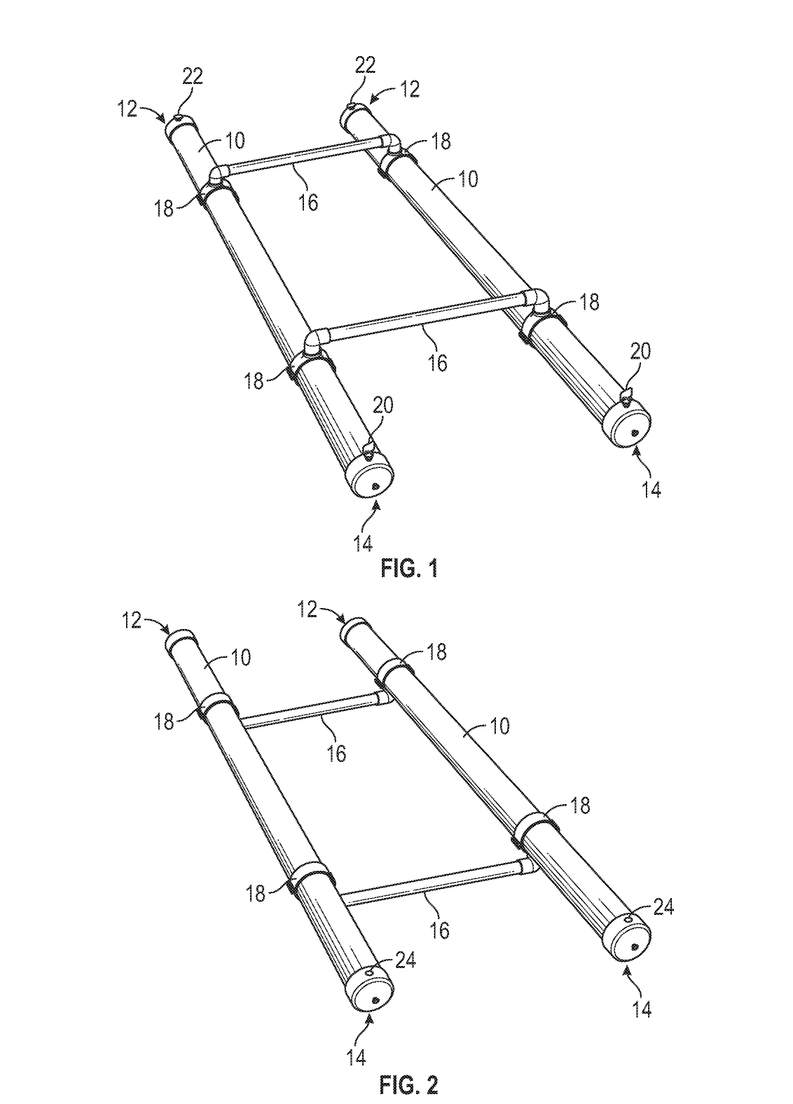

As illustrated in FIGS. 1-9, a shellfish aquaculture apparatus is provided. In a preferred embodiment, the apparatus is a pneumatically operated vessel having a “catamaran” configuration having two tubes 10 that function as pontoons and that is designed for the purpose of cultivating and transporting oysters or other shellfish. It may be an integrated design wherein the pontoons serve the dual purposes of a hull structure and of lift tubes, which are necessary for the submersion and re-emersion process. The catamaran design is inherently stable both fore-and-aft and athwart ship. It will ride comfortably in a moderate seaway. Anchoring and mooring forces are greatly reduced by the small bow area presented to breaking waves, while the tunnel formed between the tubes permits the water to flow through the vessel unrestricted. During storm conditions, the apparatus can be submerged to escape the impact of high-energy waves. Additionally, the round forms of the structural members are labor-friendly having no hard corners or sharp edges to injure workers while loading and unloading oysters. The apparatus comprises at least two spaced tubes 10 but may alternatively comprise three or more spaced tubes.

As illustrated in FIG. 1, the device comprises two spaced tubes 10 each having a first end 12 and a second end 14. As used herein, the term “tubes” may refer to cylindrical tubes having end caps, pipes, pontoons, or any other elongated structures that are hollow and suitable for providing floatation. In one embodiment, the two tubes may be 12-inch diameter pipes sealed with end caps. It is understood that tubes or pontoons may have different diameters and may come in different configurations and orientations, including, but not limited to, a single molded piece for each tube. The base tubes are preferably cylindrical but may have any suitable shape or configuration. The tubes are spaced apart from each other to provide a base support of floatation so that the apparatus may float while supporting weight.

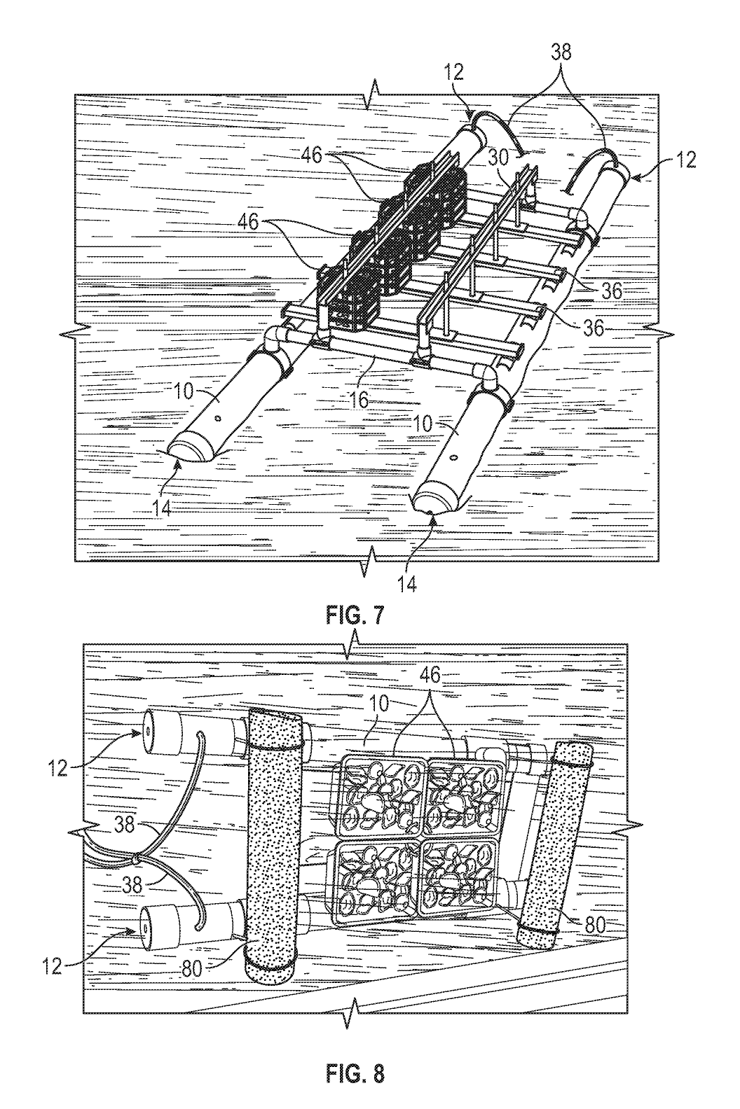

As shown in FIG. 7, the apparatus further comprises a supply line 38 for providing air or other gas to an interior of each of the tubes for floatation. Preferably, each supply line 38 is secured to the first end 12 of each tube 10. It is understood that flexible or rigid hoses, tubes, pipes, or similar conduit may be used. The supply lines are preferably one-inch flexible hoses. As shown in FIG. 1, each tube may have a connector 22 for connecting and disconnecting air supply lines 38 to the tubes. Each tube 10 also has an exhaust port 24 positioned at the second end 14 of each tube 10 generally opposite the connector 22 for the supply line 38. Each tube 10 has a top side and bottom side when the apparatus is upright in a floating position, as best seen in FIG. 7. In a preferred embodiment, the supply lines are connected to the top side of each tube via the connectors 22, as shown in FIG. 1. As shown in FIG. 2, which illustrates the bottom side of the apparatus, the exhaust ports 24 are preferably on the bottom side. In order to submerge and re-float the apparatus, it is generally necessary for the apparatus to have exhaust ports 24 for allowing water to enter the interior of the tubes and for displacing water from the tubes.

In addition to the exhaust ports, in another embodiment, a vent hole may be positioned on the top side of each tube at the second end 14 of the tube 10 above the exhaust port 24. In this embodiment, the apparatus further comprises a removable plug 20 configured to plug the vent hole. In an alternative embodiment, each tube may have a pressure relief valve located on the top side of each tube above the exhaust ports that allows air to be vented through the relief valve but prevents water from passing through the relief valve. Other embodiments may comprise other elements and mechanisms known in the art for keeping water from entering the vent hole.

The apparatus further comprises a compressed air source configured to supply air to the tubes 10 via each of the supply lines 38. FIG. 4 illustrates a manifold 40 configured to control a flow of air from the air source into and out of the tubes 10. The manifold may be connected to the air source by a connecting nozzle on the manifold so that the flow of air through the manifold is controlled by a primary air valve 42. Two separate air valves 44 may individually control the flow of air to each of the tubes 10, respectively, via each of the supply lines 38.

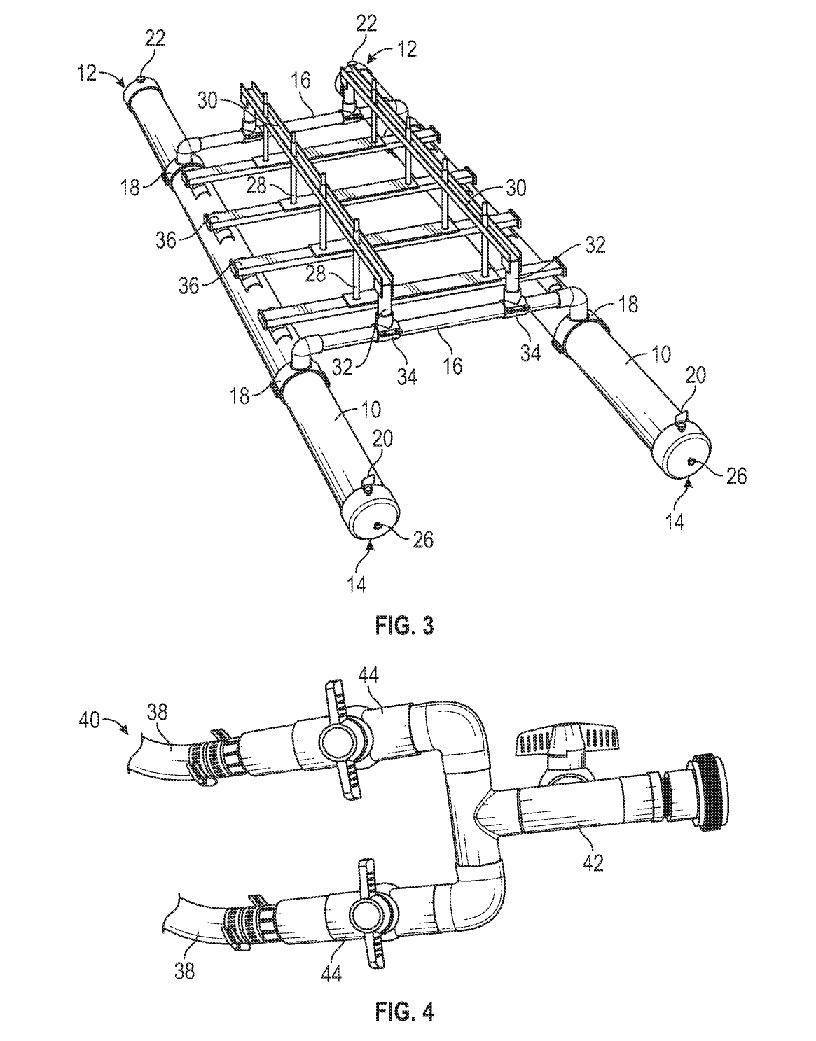

The apparatus further comprises a support structure that rigidly connects the two tubes 10. As best seen in FIGS. 6 and 7, the support structure is configured to support the weight of containers 46 holding oysters or other shellfish. In a preferred embodiment, as shown in FIG. 3, the support structure comprises two spaced beams 16 and one or more support elements 36 positioned between the beams 16.

Preferably, a plurality of support elements are utilized. The beams and support elements are both rigidly connected to each of the tubes. In a preferred embodiment, the two beams are arched beams, which helps to provide rigidity to the structure. The first beam is preferably positioned towards the first end of the tubes, and the second beam is positioned towards the second end of the tubes. In a preferred embodiment, the first beam 16 is positioned a first distance from the first end 12 of the tubes 10, the second beam 16 is positioned a second distance from the second end 14 of the tubes 10, and the first distance is longer than the second distance. This embodiment may be advantageous when a user is raising the apparatus from the sea floor to the water surface.

The apparatus set forth herein may be used for securing and holding various containers 46, which may include carriers, cages, or other devices suitable for holding and growing shellfish. The container 46 may be secured to a beam 16, a support element 36, or a tube 10. In a preferable embodiment, containers may be secured to both beams. In yet another embodiment, containers may be secured to both tubes. In yet another embodiment, containers may be secured to only one tube. Containers 46 may be secured directly to the support structure or tubes with any securing means known in the art, such as a strap, tie-down, rope, or the like. In an alternative embodiment, the containers may be secured to the beams, support elements, or tubes by strapping the containers thereto with fabric straps.

In a preferred embodiment, each support element 36 has at least one recessed hole therein that is sized to receive a vertical pole 28 therein. The recessed hole may be sized to receive an extension of the vertical pole having a diameter that is less than a diameter of the recessed hole and less than a diameter of the pole. In this way, the pole extension may be rigidly secured to and extending upwardly from the support element. The apparatus preferably comprises a plurality of poles for supporting containers 46 holding shellfish.

Many containers commonly used in the aquaculture industry are cages that are generally square shaped with a center hole. A user may secure such a container to the apparatus by inserting the pole 28 through the center hole of the container and resting the container on the support element. The extension of the vertical pole will extend into the recessed hole of the support element, and the pole will be rigidly secured to the support element. The vertical pole will extend vertically from the support element through each hole of the acquaculture cages, providing additional support.

In order to provide further support, the apparatus may further comprise a fastening element 30 configured to fasten to the support structure. The fastening element may be secured to supports 32 connected to each of the beams 16. The supports 32 may have a predetermined height allowing for a specific number of aquaculture cages 46 to fit below the fastening element 30 and above the support element 36. As shown in FIG. 6, in one embodiment, the support structure comprises supports 36 having a height sufficient to fit six cages 46 below the fastening element. When fastened in place, the fastening element secures the containers holding oysters to the apparatus so that the containers would remain fastened to the apparatus even if the apparatus were overturned.

The fastening element may have a plurality of holes each sized to receive one of the vertical poles 28 therethrough. In this embodiment, each vertical pole may extend through the hole of the fastening element. The fastening element may be positioned above the support element with the vertical pole extending from the recessed hole in the support element on one end through the hole in the fastening element on the other end. In an advantageous embodiment, the fastening elements are removably secured to the two beams via the supports 32.

In order to provide further support, the apparatus may further comprise a stabilization element having a hole sized to receive the vertical pole therethrough. In this way, the stabilization element may slidably move on the vertical pole. In a preferred embodiment, as best seen in FIG. 3, the stabilization element has two holes for two poles and is generally perpendicular to the tubes and to fastening element. Together, the vertical poles, fastening elements, and stabilization elements provide the acquaculture cages 46 support along a Y-axis, Z-axis, and X-axis, respectively, of the cages.

In some aquatic environments, it may be beneficial to provide a riser attached to the bottom side of the first end of each tube so that the apparatus is not level with the water bottom upon which it rests. In this embodiment, the risers will cause the side of the tubes with the riser attached to be raised higher than the opposite side. This embodiment may be preferable in assisting the side with the risers attached thereto to float to the surface of the water before the side without the risers.

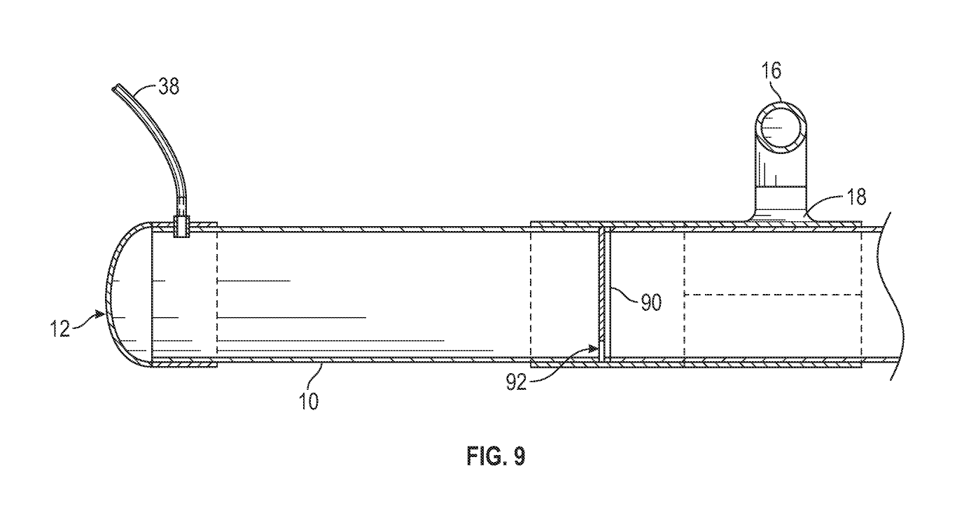

In a preferred embodiment, as shown in FIG. 9, the interior of the tubes 10 may be subdivided into two chambers by a bulkhead 90 having a relief port 92 therethrough, preferably positioned near a bottom end of the bulkhead. When submerging or floating the apparatus, the relief port 92 slows the flow of air or water between the two chambers, which may help to provide a controlled submersion or floatation of the apparatus.

In alternative embodiment, as shown in FIG. 8, the apparatus further comprises two spaced floats 80, which are each secured to the top side of both of the tubes 10. This embodiment may be advantageous in environments in which the bottom of the sea floor contains contaminants that may be detrimental to oyster growth. As such, it may be preferable for shellfish to be grown below the water surface but above the sea floor. The floats may be used to keep the apparatus near the surface of the water with the cages of oysters suspended in the water column. In one embodiment, a first float is attached to the first end of each tube, and a second float is attached to the second end of each tube. The floats 80 are preferably oriented perpendicularly to the tubes.

In order to control the flow of air into and out of the tubes, the apparatus may comprise a primary air control valve 42 configured to control a supply of air from a compressed air source to each of the tubes. In a preferred embodiment, a plurality of valves may be configured on a manifold 40. The manifold may comprise two valves 44 each connected to one air supply line 38 that is connected to one of the tubes 10.

To submerge the apparatus from the floating position, in which the tubes are filled with air, a user first opens all valves 42 and 44 on the manifold 40 to allow the pressurized air to escape from the tubes 10. During the process of submerging the apparatus, the manifold is connected to the compressed air source. The primary valve 42 should preferably be opened slowly after the other valves 44 have been opened. As the internal air pressure is reduced, water will enter the interior of the tubes through the exhaust ports 24, thereby causing the end of the apparatus with the exhaust ports to sink. The remaining air pressure in the opposing end of the apparatus to which the air supply lines are connected will cause that end to remain floating. As the buoyancy further decreases, the apparatus with its load of oysters, will continue sinking until the end with the air supply lines contacts the bottom so that the apparatus is resting on the water bottom. The user then closes all valves once both ends of the apparatus are contacting bottom.

To float the apparatus from the submerged position, in which the tubes are filled with water, the manifold is first connected to the compressed air source. The user will then open the air supply valves 44 and then slowly open the primary air supply valve 42, thereby causing air to flow into the interior of the tubes 10. As the air pressure in the tubes 10 is increased, the end of the apparatus to which the air supply lines are connected starts to rise. Once this end rises from the bottom, it will then float at the surface without supplying additional air. With this end on the surface and the opposing end on the bottom, the apparatus is in a stable position. As more air is supplied to the tubes, water is displaced from the tubes due to the air causing the water to be discharged through the exhaust ports 24. The end of the apparatus with the exhaust ports will then begin to float from the water bottom to the surface, and the entire apparatus will then be floating. When air bubbles begin to stream from the exhaust ports 24 to the surface of the water, this signals that all of the water in the tubes has been evacuated and full buoyancy has been achieved. The air supply valves 42 and 44 should be closed immediately to conserve air pressure.

For desiccation, the apparatus is generally left on the surface of the water where it will remain for approximately 24 hours. During this time, the oysters will dry and purge themselves from bio-fouling. The surface desiccation cycle and the submerged growing cycle will be repeated until the oysters mature and are ready to harvest.

Accordingly, the present shellfish aquaculture apparatus is configured for use in two positions: the floating position and the submerged position. The tubes are filled with air when in the floating position, and with water when in the submerged position. When in the floating position, the containers and the shellfish contained therein are lifted above the surface of the water. The containers and shellfish can be held in this position for a period of time sufficient to allow air desiccation in order to prevent the formation of biofilm on the containers and shellfish, which is a precursor to bio-fouling by barnacles or other unwanted organisms. Other shellfish husbandry activities such as stocking containers, sorting shellfish by size, and harvesting are also facilitated while the apparatus is in the floating position. Additionally, the apparatus can be disconnected from moorings and towed away to avoid hazards or towed to a more favorable location for growth or acquisition of quality growth characteristics such as salinity. When in the submerged position, the tubes rest on the water bottom and hold the containers and shellfish contained therein off the water bottom to allow shellfish growth before harvesting.

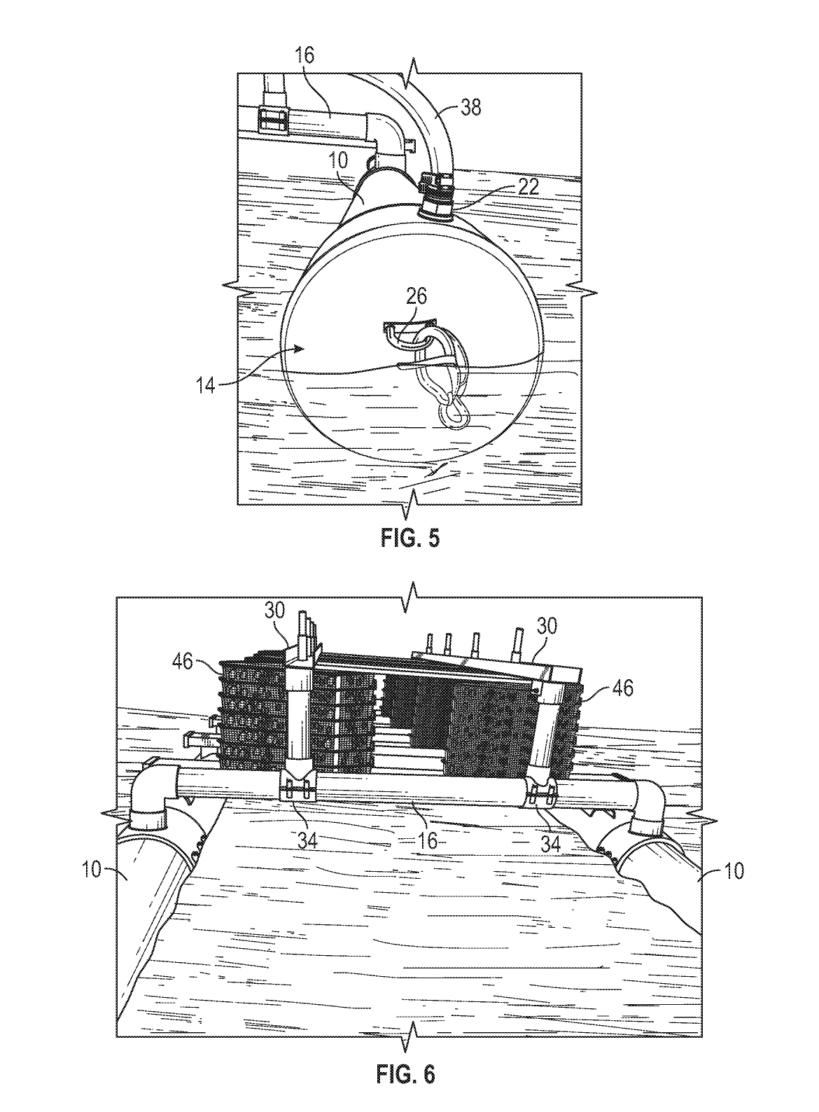

A single unit or a train of units linked together may be towed behind a motorized vessel. To facilitate towing, one or both ends of each tube 10 may have a loop 26 installed therein, as shown in FIG. 5, for securing a tow rope, chain, or similar type of tow line. This mobility makes it possible to escape adverse environmental conditions such as oil spills, sewerage discharges, algae blooms and storm water pollution. The mobility of the present apparatus on the surface of the water is enhanced by the “catamaran” design. Both the arched beams 16 connecting the two tubes 10 and the support elements 36 supporting the oysters are well above the surface of the water where they offer no resistance underway. This design reduces towing forces and increases towing speed permitting an increase in the range of towing operations. An additional advantage of mobility is the ability to relocate mature oysters from a brackish water area where they are grown to a water body with a higher salt content. The oysters can be relocated and submerged there for several days to obtain a salty taste prior to going to market, which may increase the market value of the shellfish.

To facilitate submerging and floating the apparatus, the manifold 40 has a connection nozzle for a primary air supply line from a compressed air source and a primary air supply valve 42. The air source is preferably a pressurized tank, which may be a SCUBA tank. The air source may alternatively be an air compressor. The air source may have a supply line and associated valve for shutting off airflow when connecting the air source to the manifold. The primary air supply valve allows a user to isolate the compressed air source from the manifold by closing the valve 42 or to supply compressed air to the manifold by opening the valve. The manifold further comprises a plurality of valves 44 for individually controlling the flow of air to each of the tubes 10. By supplying compressed air to the manifold and opening a valve 44, an air supply line 38 will supply compressed air to a corresponding tube 10. If the tube contains water, the water will be displaced by the air and pushed out of the exhaust port 24 on the bottom side of the tube. The displacement of the water by air will cause the tube to float. Displacing the water with air in all of the tubes will float the entire apparatus, including the containers 46 secured thereto.

The apparatus of the present disclosure is additionally advantageous compared to known shellfish aquaculture systems because it eliminates the time consuming manual labor involved with flipping containers. When manually flipping shellfish containers, the capacity of a unit of containers is generally limited to about one thousand average sized oysters due to weight consideration in a manual operation. The pneumatically controlled apparatus may be capable of handling units of shellfish containers holding significantly larger quantities and greater weights of shellfish. Utilizing larger production units reduces labor from handling smaller units, thereby increasing the capacity of the operation and reducing production costs. Larger units are also more resilient to severe weather and to theft. The apparatus also reduces risks associated with manual flipping, such as falls, drowning, hypothermia, wound infections, stings or bites from jellyfish or other sea animals, or other similar risks.

It is understood that versions of the present apparatus may be constructed with any suitable materials. However, in a preferred embodiment, the apparatus may be constructed entirely from schedule 40 PVC Pipe and Fittings which are commercially available. All fixed connections may be glue-welded while connections designed to be disassembled for shipping may be fastened with stainless steel bolts. Both PVC and stainless-steel are salt water tolerant making them ideal for the intended use. Alternatively, the present apparatus may be constructed of ABS plastic, which may be corrugated ABS plastic. Various components of the apparatus may also be constructed of aluminum, steel, wood, or other suitable materials as appropriate.

For instance, in one preferred embodiment, the tubes 10 may be constructed of two twenty-foot lengths of twelve-inch schedule 40 PVC pipe and four twelve-inch schedule 40 PVC end caps to seal the ends of the pipe. The tubes may be positioned so that the tubes are spaced approximately seven feet apart from each other. A half-inch diameter stainless steel “U” bolt, which may serve as a mooring and towing bit 26, may be installed through the center face of each cap. The exhaust ports 24 may be 2.5 inches in diameter and centered three inches forward of the end caps on the bottom side of each tube. The connectors 22 for the air supply lines 38 may be formed by a 1.25 inch diameter hole on the top side of each tube to form an inlet for the pressurized air. The hole may be threaded with a one-inch NPT tap to receive a one-inch brass hose barb. The hose barb may then be installed with silicone tape to prevent air or water leaks around the fitting.

The tubes may be joined together with two PVC arched beams 16 rigidly connected to the 12-inch pipe with tapping saddles 18. As used herein, a tapping saddle is a tee manufactured in two halves. The top half has an added socket forming the tee. The top and bottom halves are bolted together around the pipe 10 with stainless steel bolts located on each side. The arched beams 16 may be formed from six foot eight inch lengths of four-inch diameter schedule 40 PVC pipe and glue-welded to four-inch schedule 40 PVC elbows at each end. The tapping saddles 18 nearer the first end 12 of the tubes may be positioned five feet and eight inches from the first end, and the tapping saddles nearer the second end 14 may be positioned four feet and four inches from the second end. The centerline-to-centerline space between the front and rear saddles may be ten feet. The supports 32 may also be connected to the beams 16 using tapping saddles 34. The support elements 36 may be constructed of aluminum and may be seven foot six inches in length.

It is understood that any type of shellfish growing cages or containers may be utilized with the present apparatus. In a preferred embodiment, the cages may be constructed of one-eighth inch diameter, plastic covered, galvanized wire measuring three-feet by four-feet by twelve-inches high with a center wire partition and a horizontal wire shelf subdividing the cage into four compartments. Each cage may have a wire door that opens vertically to access the compartments which contains one perforated plastic bag containing one hundred fifty oysters. Each cage contains six hundred oysters. Four cages may be installed directly on the four support elements with four additional cages mounted directly on top of the first. The eight cages will hold thirty-two bags containing four thousand eight hundred oysters. The first level of four wire cages may be secured to the support structure and the second level may be secured to the first level.

If the stacked basket system is selected, additional fabrication and materials may be required. The stacked tray system may comprise two-feet by two-feet semi-hexagonal, perforated plastic, stackable, interlocking baskets with one and one quarter inch diameter poles run vertically through the center of each stack locking the baskets together. The baskets may be 3-inches high with an additional one half-inch interlocking rim. They may be stacked six baskets high with an additional empty tray which serves as a cover. The total stack may measure twenty-one and one-half inches high. Each tray may contain one hundred oysters with six hundred oysters per stack. The apparatus may support two rows of eight stacks mounted directly on the support elements with fastening element mounted above the two rows of stacks to secure them in place. Both the top and bottom fastening elements may be drilled with holes spaced twenty eight-inches on center to accommodate the poles which pass through the fastening elements.

Once fabricated the present apparatus may be disassembled into its major parts, transported to the location of intended use, and re-assembled in the water. In one embodiment, the device comprises four PVC assemblies, two PVC pontoons, and two arched PVC cross beams.

It is understood that versions of the invention may come in different forms and embodiments. Additionally, it is understood that one of skill in the art would appreciate these various forms and embodiments as falling within the scope of the invention as disclosed herein.

What is claimed is:

1. A shellfish aquaculture apparatus, comprising:
a base comprising two spaced tubes, wherein each tube has a first end and a second end,
a supply line secured to the first end of each tube for providing air to the tubes,
an exhaust port positioned at the second end of each tube for displacing air from the tubes, and
a support structure rigidly connecting the tubes.

2. The apparatus of claim 1, further comprising a compressed air source configured to supply air to the tubes via each of the supply lines.

3. The apparatus of claim 2, further comprising a manifold configured to control a flow of air from the air source.

4. The apparatus of claim 1, wherein each tube has a top side and a bottom side, wherein each supply line is secured to the top side of each tube and wherein each exhaust port is positioned on the bottom side of each tube.

5. The apparatus of claim 4, wherein a vent hole is positioned on the top side of each tube at the second end of each tube, wherein the apparatus further comprises a removable plug configured to plug each vent hole.

6. The apparatus of claim 1, wherein the support structure comprises two spaced beams each rigidly connected to each of the tubes, wherein the first beam is positioned a first distance from the first end of the tube and the second beam is positioned a second distance from the second end of the tube, wherein the first distance is longer than the second distance.

7. The apparatus of claim 1, further comprising a vertical pole rigidly secured to and extending upwardly from the support structure.

8. The apparatus of claim 7, further comprising a fastening element having a hole sized to receive the vertical pole therethrough, wherein the fastening element is configured to fasten to the support structure.

9. The apparatus of claim 8, further comprising a stabilization element having a hole sized to receive the vertical pole therethrough.

10. The apparatus of claim 1, wherein each tube is subdivided into two chambers by a bulkhead having a relief port therethrough.

11. The apparatus of claim 1, further comprising two spaced floats, wherein each float is secured to both of the tubes.

12. The apparatus of claim 11, wherein each float is positioned perpendicularly to each of the tubes.

13. A shellfish aquaculture apparatus, comprising:
a base comprising two spaced tubes, wherein each tube has a first end and a second end;
a supply line secured to a top side of the first end of each tube for providing air to the tubes;
an exhaust port positioned on a bottom side at the second end of each tube for displacing air from the tubes;
two spaced beams each rigidly connected to each of the tubes, wherein the first beam is positioned a first distance from the first end of the tube and the second beam is positioned a second distance from the second end of the tube, wherein the first distance is longer than the second distance;
a support element positioned between the beams, wherein the support element is rigidly connected to each of the tubes and has at least one recessed hole therein;
a vertical pole rigidly secured to and extending upwardly from the support element, wherein the at least one hole in the support element is sized to receive the pole therein; and
a fastening element having a hole therethrough sized to receive the vertical pole therethrough, wherein the fastening element is removably fastened to each of the beams and positioned above the support element with the pole extending through the hole in the fastening element;
wherein the support element is positioned perpendicularly to each of the tubes and the fastening element.

14. The apparatus of claim 13, further comprising a compressed air source configured to supply air to the tubes via each of the supply lines.

15. The apparatus of claim 14, further comprising a valve configured to control a flow of air from the air source.

16. The apparatus of claim 14, further comprising a manifold configured to control a flow of air from the air source.

17. The apparatus of claim 13, wherein each tube is subdivided into two chambers by a bulkhead having a relief port therethrough.

18. The apparatus of claim 13, further comprising two spaced floats, wherein each float is secured to both of the tubes.

19. The apparatus of claim 18, wherein each float is positioned perpendicularly to each of the tubes.
